(19) United States
(12) Patent Application Publication
(10) Pub. No.: US 2026/0254721 A1
(43) Pub. Date: Aug. 27, 2026

(54) COMMAND TO REMOVE ONE OR MORE NETWORK DEVICES

(71) Applicant: INTERNATIONAL BUSINESS MACHINES CORPORATION, Armonk, NY (US)

(72) Inventors: Pasquale A. Catalano, Wallkill, NY (US); John S. Werner, Fishkill, NY (US); Andrew G. Crimmins, Montrose, NY (US); Arkadiy O. Tsfasman, Wappingers Falls, NY (US)

(21) Appl. No.: 19/065,391

(22) Filed: Feb. 27, 2025

(51) Int. Cl. H04L 41/08; H04L 67/1097

(52) U.S. Cl. CPC H04L 41/0879; H04L 67/1097

(57) ABSTRACT

A receiving network device obtains a command built to enable a control program of a device coupled to the receiving network device to request removal of a network device. The command includes an indication of the network device, and the receiving network device initiates removal of the network device indicated by the command. The initiating removal of the network device includes initiating removal of one or more paths of the network device. The receiving network device provides a response to the request for removal of the network device.

### BACKGROUND

One or more aspects relate, in general, to facilitating processing within a computing environment, and in particular, to facilitating communication within the computing environment.

Certain computing environments use networks, such as storage area networks and/or other networks, to provide access between devices. For example, a storage area network provides data paths between one or more host devices and one or more storage devices. The data paths may include network devices, such as switches, and/or other devices, as well as communication links. The links may be fiber optic or other types of cables or even wireless.

### SUMMARY

Shortcomings of the prior art are overcome, and additional advantages are provided through the provision of a computer program product. The computer program product includes a set of one or more computer-readable storage media and program instructions, collectively stored in the set of one or more computer-readable storage media, for causing at least one device to perform computer operations. The computer operations include obtaining, by a receiving network device, a command built to enable a control program of a device coupled to the receiving network device to request removal of a network device. The command includes an indication of the network device, and the receiving network device initiates removal of the network device indicated by the command. The initiating removal of the network device includes initiating removal of one or more paths of the network device. The receiving network device provides a response to the request for removal of the network device.

Computer-implemented methods and systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate, perform and/or use one or more aspects of the present disclosure;

FIG. 2A depicts one example of aspects of a storage area network to incorporate, perform and/or use one or more aspects of the present disclosure;

FIG. 2B depicts one example of a network device coupled to a plurality of devices, in accordance with one or more aspects of the present disclosure;

FIG. 3A depicts one example of the network device (e.g., path) removal code of FIG. 1, in accordance with one or more aspects of the present disclosure;

FIG. 3B depicts one example of command build/send code of the network device (e.g., path) removal code of FIG. 3A, in accordance with one or more aspects of the present disclosure;

FIG. 3C depicts one example of command receive/remove code of the network device (e.g., path) removal code of FIG. 3A, in accordance with one or more aspects of the present disclosure;

FIG. 4 depicts one example of a command build/send process, in accordance with one or more aspects of the present disclosure;

FIG. 5A depicts one example of a control unit port command to request removal of a network device, in accordance with one or more aspects of the present disclosure;

FIG. 5B depicts one example of information transmitted and/or received based on the control unit port command of FIG. 5A, in accordance with one or more aspects of the present disclosure;

FIG. 5C depicts further details of one example of the status provided in a response to the control unit port command, in accordance with one or more aspects of the present disclosure; and

FIG. 6 depicts one example of a command receive/remove process, in accordance with one or more aspects of the present disclosure.

### DETAILED DESCRIPTION

In accordance with one or more aspects of the present disclosure, a capability is provided to facilitate processing within a computing environment. In one aspect, the capability includes facilitating communication within the computing environment by improving the use of devices/device components of a network, such as, for instance, a storage area network used to provide data paths between host devices and storage devices.

In one example, to improve utilization of devices of a storage area network (or other network), such as network devices (e.g., switches, directors, routers, appliances, etc.), of components of the network devices (e.g., ports that receive and/or transmit data, blades, fans, chassis, etc.), of links between the devices, of other devices of the storage area network, and/or of devices coupled to the storage area network, a capability is provided to request removal of one or more network devices. The request is based on a determination (e.g., by an operating system or other control program) that the one or more network devices are not to be used for one or more reasons, such as failure, a security vulnerability, etc. This is useful in, e.g., improving routing of traffic through, e.g., a network (e.g., a storage area network). For instance, if it is decided that one or more network devices are not performing satisfactorily or have a security vulnerability, then those one or more network devices may be removed. This enables a network device, a link, a path and/or a port, etc. to be bypassed; unenabled; deleted; turned off; etc. It also allows the selection or enabling of other network devices, links, paths, ports, etc. Other examples are possible.

The removal of the network device(s) is performed based on, e.g., a command built and sent from one device, e.g., a host device, to another device, e.g., a receiving network device. The command is built by, using and/or on behalf of a control program (e.g., an operating system, other control program, etc.) of the one device to enable the control program to request removal of the one or more network devices. The receiving network device receives and runs the command. Based on a command structure of the command, the receiving network device at least initiates removal of the network device(s) indicated in the command. In one example, this includes initiating removal of one or more paths of the specified network device(s), which includes, for instance, initiating the removing (e.g., unenabling, deleting, switching offline, etc.) of one or more ports of the specified network device(s). Other examples of initiating removal of the network device(s) and/or of the paths are possible.

In one example, the receiving network device is part of a storage area network, and the device building/transmitting the command may be part of the storage area network or separate therefrom and coupled to the receiving network device, and optionally, one or more other devices of the storage area network.

As examples, the receiving network device initiates and performs network device removal (e.g., path removal) without using another network device and/or other device; and/or the receiving network device uses one or more other network devices (and/or other device(s)) to initiate and/or perform network device (e.g., path) removal. For instance, in one example, the receiving network device initiates and performs network device (e.g., path) removal based on information accessible to the receiving network device (e.g., identifiers, such as request node identifiers and/or other identifiers, other information, etc.); in another example, the receiving network device forwards at least an indication of the command to at least one other network device (and/or other device(s)) coupled to the receiving network device to initiate network device (e.g., path) removal; in a further example, the receiving network device initiates and/or performs network device (e.g., path) removal based on information accessible to the receiving network device and forwards at least an indication of the command to one or more other network devices (and/or other device(s)) to initiate and/or perform network device (e.g., path) removal. Many possibilities exist.

As examples, the network device indicated in the command is the receiving network device; the network device indicated in the command is another network device; and/or multiple network devices are indicated in the command, which may or may not include the receiving network device. Various examples are possible. The receiving network device and the other network devices are part of a storage area network, in one example. The storage area network is coupled, in one example, to the device sending the command requesting the removal of the one or more network devices. Other examples are possible.

One or more aspects of the present disclosure are incorporated in, performed and/or used by a computing environment. As examples, the computing environment may be of various architectures and of various types, including, but not limited to: personal computing, client-server, distributed, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) that, e.g., removes one or more network devices (e.g., one or more paths of the one or more network devices) and/or performs one or more other aspects of the present disclosure. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

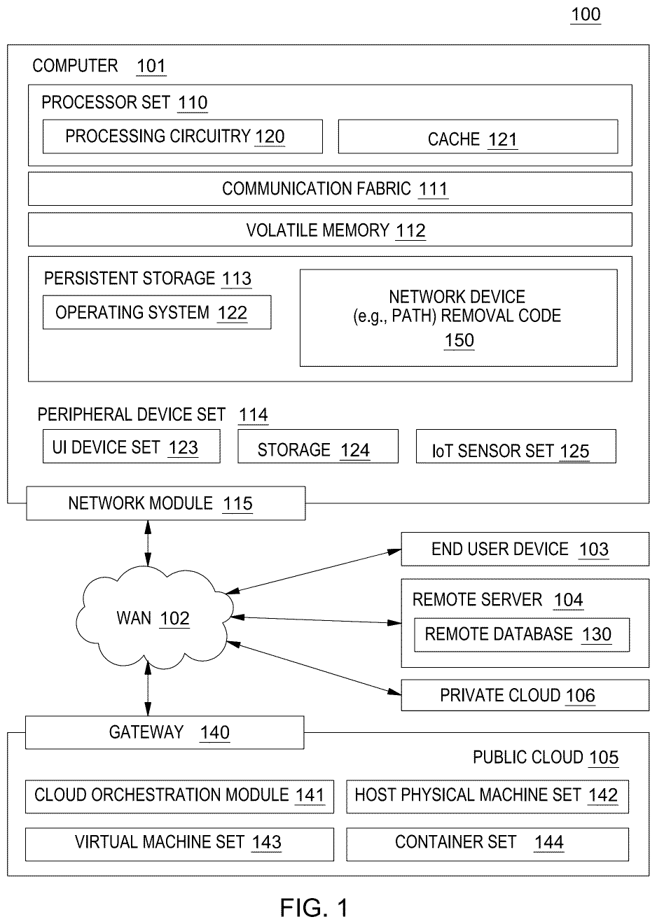

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as network device (e.g., path) removal code 150 (also referred to herein as block 150). In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106, 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. For instance, in one or more embodiments, one or more of the components/modules/blocks of FIG. 1 are not included in the computing environment and/or are not used for one or more aspects of the present disclosure. Further, in one or more embodiments, additional and/or other components/modules/blocks may be used. Other variations are possible.

Further details relating to one or more components/modules/blocks of FIG. 1 used in accordance with one or more aspects of the present disclosure are described herein. For example, storage 124 is provided, in one example, by a storage network, such as a storage area network (SAN). In one example, a storage area network includes a plurality of devices coupled to one another via a plurality of connections. As examples, the plurality of devices includes one or more endpoint devices (e.g., one or more servers, such as computer(s) 101; one or more processors and/or nodes of a processor set (e.g., processor set 110); one or more remote servers, such as remote server(s) 104; and/or one or more end user devices, such as end user device(s) 103; etc.), one or more network devices (e.g., switches, directors, routers, appliances, etc.), one or more storage devices, and/or one or more other devices; and the connections include, for instance, links and/or other connections. Many examples are possible.

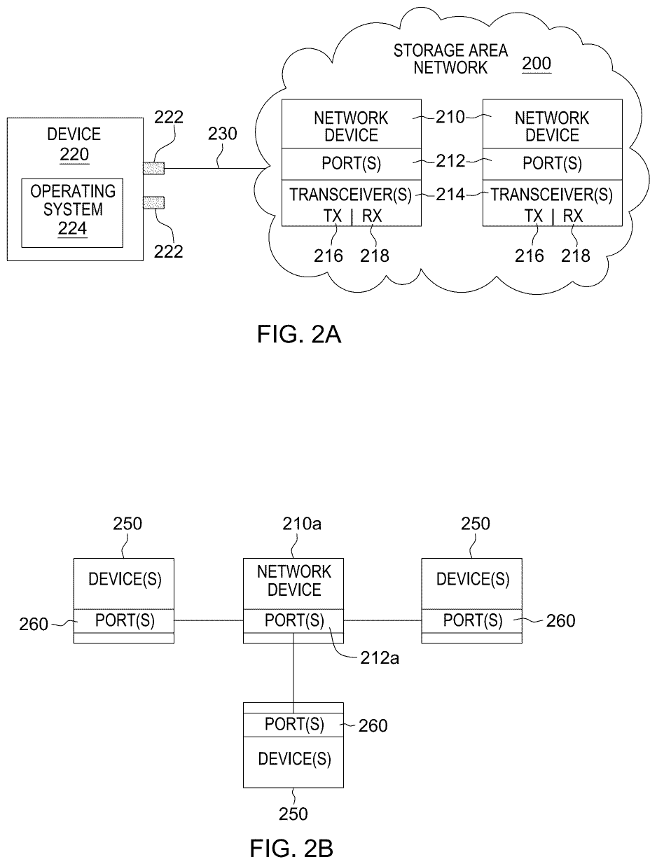

One example of network devices of a storage area network is described with reference to FIG. 2A. In one example, a storage area network 200 includes one or more network devices 210, such as one or more switches, directors, routers, appliances, etc. As examples, one or more of network devices 210 support the Fibre Channel and/or Fibre Channel over Ethernet protocols. Although the Fibre Channel and/or Fibre Channel over Ethernet protocols are specified herein, one or more of the network devices may support other protocols. Fibre Channel and/or Fibre Channel over Ethernet protocols are just examples. Further, in one or more examples, storage area network 200 may be or include a network fabric, such as a switched fabric, which includes, for instance, a plurality of network devices (e.g., directors or switches based on fibre technology, other directors or switches and/or other network devices) coupled to one another via one or more connections (e.g., inter-switch links, other links and/or other connections). Various examples are possible.

Each network device 210 includes, for instance, one or more ports 212 that connect a network device to one or more other devices, including one or more other network devices and/or one or more other devices (referred to herein as non-network devices) via one or more links. A port (e.g., port 212) may receive and/or transmit data. In one example, a port (e.g., port 212) may include one or more transceivers (e.g., transceivers 214) to transmit (TX) 216 and/or receive (RX) 218 data. The transceivers may be, for instance, pluggable, optical transceivers that plug into the port(s).

In one example, one or more of network devices 210 is coupled to a device 220 via one or more links 230. As an example, the device is, e.g., a computer (e.g., computer 101, other computer, etc.), a server (e.g., server 104, other server, etc.), an end user device (e.g., end user device 103, other end user device, etc.), a processor, node and/or processing circuitry, etc. (e.g., of processor set 110 or other processor sets), other non-network device, and/or one or more other computing devices, etc. The device also includes, in one example, one or more ports 222 that connect the device to one or more network devices 210 and/or to other non-network devices. In one example, ports 222 of device 220 and/or of at least some other non-network devices (such as other endpoint devices, etc.) are referred to, in one example, as channel ports, while ports 212 of network device 210 are referred to, for instance, as switch ports. Other examples are possible.

In one example, device 220 is separate but coupled to the storage area network. In another example, it is part of the storage area network. In one example, device 220 includes an operating system (e.g., operating system 224) or another control program that sends commands from the device to, e.g., a network device coupled to the device. In one example, the device (e.g., device 220) is a host device. Other examples and/or variations are possible.

The storage area network of FIG. 2A is only one example. Storage area networks may include additional, fewer and/or other devices (e.g., network devices, non-network devices, etc.), ports and/or connections. Many examples and variations are possible. For instance, the number, type and interconnections of the devices and connections in each storage area network may be different. Further, storage area networks may support other transmission protocols. Again, many variations are possible.

Further details of one example of a plurality of devices connected to a network device of a storage area network are described with reference to FIG. 2B. In one example, a network device 210a is coupled to a plurality of devices 250. A device of the plurality of devices 250 may be a network device (e.g., switch, router, director, appliance, etc.) or a non-network device (e.g., a server, etc.). Many examples are possible. Network device 210a includes a plurality of ports 212a used to connect to a plurality of ports 260 of the plurality of devices 250. For instance, a port 212a of network device 210a is used to connect to a port of the plurality of ports 260 of a device of the plurality of devices 250. Although one example is depicted in FIG. 2B, a network device may have more or less ports and be used to connect to more or less devices via more or less ports. Many examples are possible.

In one example, to improve processing of and/or related to a storage area network (e.g., storage area network 200) and/or other networks, one or more network devices (e.g., switches, routers, directors, appliances, etc.) of the storage area network are removed. The removal of a network device includes, for instance, removing one or more paths (e.g., all the paths) of the network device. In one example, to remove a path, one or more ports of the path are unenabled (or otherwise removed, e.g., deleted, switched offline, etc.). Other examples are possible.

In one or more aspects, network device (e.g., path) removal may be triggered based on, for instance, a command requesting removal of one or more network devices. In one or more aspects, the command may be built, transmitted and received using code, such as network device removal code (e.g., network device (e.g., path) removal code 150 of FIG. 1), that includes code or instructions used to initiate and/or perform removal of one or more network devices (e.g., removal of one or more paths of the one or more network devices) indicated in the command, in accordance with one or more aspects of the present disclosure.

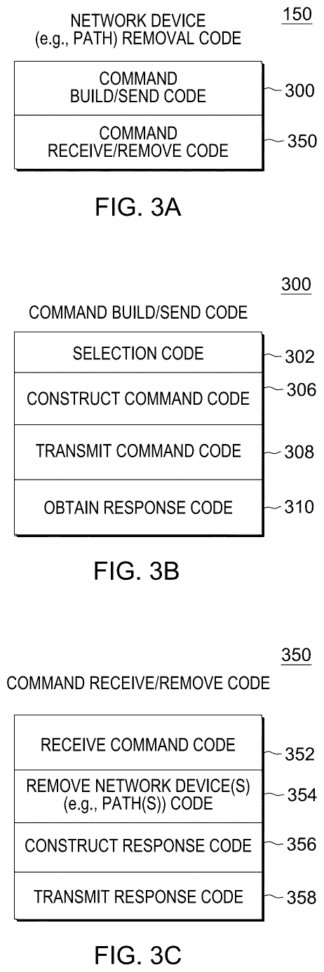

In one or more aspects, referring to FIG. 3A, network device removal code (e.g., network device (e.g., path) removal code 150) includes, in one example, various code to be used to initiate and/or perform network device (e.g., path) removal and/or to perform tasks relating thereto. The code is, e.g., computer-readable program code (e.g., instructions) in computer-readable media, e.g., storage (persistent storage 113, cache 121, storage 124, other storage, as examples). Although, as an example, network device (e.g., path) removal code 150 is depicted in FIG. 1 in persistent storage 113, the code and/or one or more portions of the code may be in other storage, such as storage 124, etc. Many variations are possible.

The computer-readable media may be part of one or more computer program products and the computer-readable program code may be executed by and/or using one or more devices (e.g., one or more computers, such as computer(s) 101; one or more servers, such as remote server(s) 104; one or more end user devices, such as end user device(s) 103; one or more processors or nodes, such as processor(s) or node(s) of processor set 110; processing circuitry, such as processing circuitry 120 of processor set 110; one or more network devices (e.g., networks devices 210 (FIG. 2A)); and/or other devices, etc.). Additional and/or other computers, servers, end user devices, processors, nodes, processing circuitry, network devices and/or other devices may be used to execute the code and/or portions thereof. Many examples are possible.

One example of network device (e.g., path) removal code 150 includes, for instance, command build/send code 300 to be used to build a control unit port command to remove one or more network devices (e.g., paths of the one or more network devices) and to send the command to a receiving device (e.g., a receiving network device); and command receive/remove code 350 to be used to receive the command and initiate and/or perform network device (e.g., path) removal. Additional, less and/or other code may be used to implement network device (e.g., path) removal. Other variations are possible. Although various code is described, network device removal code, such as network device (e.g., path) removal code 150, may include additional, less and/or different code. Particular code may include additional code, less code, and/or different code. Further, additional, less and/or other code may be used for network device (e.g., path) removal and/or perform related tasks. Many variations are possible.

Further details relating to command build/send code 300 are described with reference to FIG. 3B and further details relating to command receive/remove code 350 are described with reference to FIG. 3C. In one example, command build/send code 300 is executed on one or more non-network devices, such as device(s) 220, and command receive/remove code 350 is executed on one or more network devices, such as network device(s) 210. In one example, a non-network device (e.g., non-network device 220) executing the command build/send code is coupled to, but separate and independent of a network device (e.g., network device 210) executing the command receive/remove code. Other examples/variations are possible.

Referring to FIG. 3B, in one example, command build/send code 300 includes selection code 302 to be used to select one or more network devices (e.g., switches, directors, routers, appliances, etc.) to be removed, e.g., from a storage area network; construct command code 306 to be used to build a command, such as a control unit port command, to initiate and/or perform the removal of the one or more network devices (e.g., paths of the one or more network devices); transmit command code 308 to be used to send the built command (e.g., control unit port command) to a receiving device (e.g., a receiving network device 210); and obtain response code 310 to be used to obtain status from the receiving network device relating to the network device (e.g., path) removal and/or perform one or more tasks. The command build/send code may include additional, less and/or other code. Other variations are possible.

Referring to FIG. 3C, in one example, command receive/remove code 350 includes receive command code 352 to be used to receive the built command (e.g., control unit port command) at the receiving network device (e.g., a network device 210); remove network device(s) (e.g., path(s)) code 354 to be used to initiate and/or perform network device (e.g., path) removal for the network device(s) indicated in the command; construct response code 356 to be used to construct a response to the request for removal of one or more network devices; and transmit response code 358 to be used to transmit the constructed response to the transmitting device (e.g., operating system of the transmitting device; e.g., operating system 224). The command receive/remove code may include additional, less and/or other code. Other variations are possible.

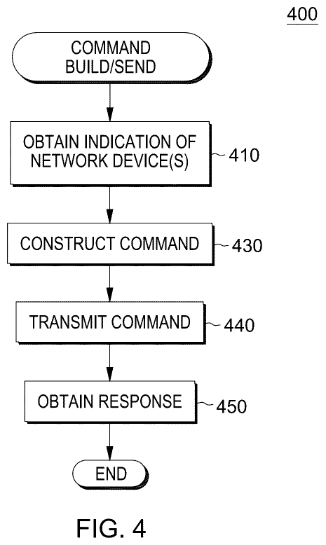

In one example, the command build/send code (e.g., command build/send code 300) is used, in accordance with one or more aspects of the present disclosure, to build a command and to transmit the command for network device (e.g., path) removal and/or to perform other tasks related thereto, as further described with reference to FIG. 4. In one example, a command build/send process (e.g., a command build/send process 400) is implemented using one or more portions of network device (e.g., path) removal code 150 (e.g., code 300-310) and is executed by a device, such as device 220. In one example, device 220 is a computing device (e.g., a computer (e.g., computer 101, other computer, etc.), a server (e.g., server 104, other server, etc.), an end user device (e.g., end user device 103, other end user device, etc.), a processor, node and/or processing circuitry, etc. (e.g., of processor set 110 or other processor sets), other non-network device, and/or one or more other computing devices, etc.). Although example computers, servers, end user devices, processors, nodes, processing circuitry and/or computing devices are provided, additional, fewer and/or other computers, servers, end user devices, processors, nodes, processing circuitry and/or computing devices may be used for the command build/send process and/or other processing. Various options are possible.

In one example, one or more aspects of command build/send process 400 (also referred to as process 400) are implemented and/or executed by, on behalf of and/or using a control program (e.g., operating system 224), other control programs, and/or other operating systems executing on a device, such as device 220 and/or other non-network devices. The device (e.g., device 220) executing the control program (e.g., operating system 224) to build and send the command is coupled to, but separate from, a network device (e.g., network device 210) receiving and running the command to initiate and/or perform network device (e.g., path) removal. In one example, the operating system (e.g., operating system 224) of the transmitting device (e.g., non-network device 220) is the z/OS® operating system offered by International Business Machines Corporation, Armonk, New York. The z/OS operating system, however, is only one example operating system; other operating systems of International Business Machines Corporation and/or of other entities/companies may include and/or use one or more aspects of the present disclosure. z/OS is a trademark or registered trademark of International Business Machines Corporation in at least one jurisdiction.

In one example, the command being built and transmitted is an architected command of a selected architecture. As an example, the selected architecture is the z/Architecture® instruction set architecture offered by International Business Machines Corporation, Armonk, New York. One embodiment of the z/Architecture instruction set architecture is described in a publication entitled, “z/Architecture Principles of Operation,” IBM Publication No. SA22-7832-13, Fourteenth Edition, May 2022, which is hereby incorporated herein by reference in its entirety. The z/Architecture instruction set architecture, however, is only one example architecture; other architectures and/or other types of computing environments of International Business Machines Corporation and/or of other entities/companies may include and/or use one or more aspects of the present disclosure. The z/Architecture instruction set architecture and the z/OS operating system are only examples and are not meant to be limiting in any way. z/Architecture and IBM are trademarks or registered trademarks of International Business Machines Corporation in at least one jurisdiction.

In one example, referring to FIG. 4, process 400 obtains 410 (e.g., using selection code 302) an indication of one or more network devices (e.g., switches, directors, routers, appliances, etc.) to be removed. For example, one or more network devices of interest are determined and provided to process 400. The network device(s) may be, for instance, switch(es) (and/or other network device(s)) of a storage area network (or other network). The selections may be performed by, for instance, a user at a device, such as device 220, via, e.g., an operating system (e.g., operating system 224) or the selections may be determined by the host (e.g., operating system) or other application, control program, etc. In one example, the control program (e.g., operating system 224) executing on the non-network device (e.g., non-network device 220) determines, based on information it possesses or obtains (e.g., input/output (I/O) configuration data, potential or actual I/O configuration changes, performance data, security information, etc.), that it would be beneficial to remove one or more network devices of the storage area network. Other examples are possible.

The one or more network devices selected may be selected periodically, randomly, based on a schedule, based on an I/O configuration change, based on a performance or security concern or a perceived performance or security concern or for any other reason.

Process 400 constructs 430 a command (e.g., using construct command code 306), such as a control unit port command, to remove the one or more selected network devices. For instance, the process (e.g., using the operating system) constructs the control unit port command using the selected network device(s) information. In one example, it populates a command structure of the command, an example of which is described below, with, e.g., an identifier of the receiving network device, an identifier of the transmitting device and/or identifier(s) of the network device(s) selected to be removed. Other examples are possible.

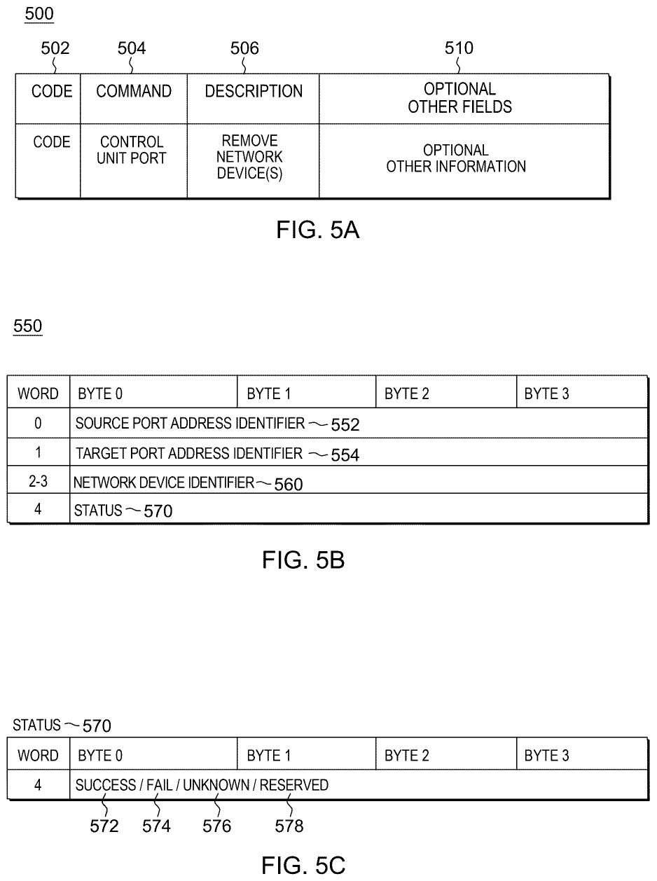

One example format of a command to be constructed is depicted in FIG. 5A. As shown, in one example, a command format 500 includes a code field 502, which includes a unique code identifying the command; a command field 504, which indicates the command, such as a control unit port command (and may or may not specify what action the command is performing); a description field 506, which provides a description of the command, such as remove network device(s); and optionally, there may be one or more other fields 510. As examples, the one or more other fields may include one or more of a test key and increment field, which indicates whether a test key and increment command with an equal test comparison is to be included in the same channel command word chain prior to this command; an identify field, which indicates whether an identify command is to be included in the same channel command word chain prior to this command; an accepted with host control prohibited field, which indicates whether this command will be accepted or not when host control is prohibited; and/or a count field, which indicates an amount of data to be transferred. Additional, fewer and/or other fields are possible. Other command formats are also possible. The command format may include additional, fewer and/or other fields/information. Many variations are possible.

One example of the information transferred and/or received using the control unit port command is described with reference to an example command structure depicted in FIG. 5B. In one example, a command structure 550 has one or more fields including information, such as, for instance:
Source Port Address Identifier 552 (e.g., bytes 0-2 of word 0): This field includes information regarding the port on the endpoint side. For instance, an identifier of the port used to transmit the command (e.g., a port of the transmitting device).
Target Port Address Identifier 554 (e.g., bytes 0-2 of word 1): This field includes information regarding the port on the target side. For instance, an identifier of the port used to receive the command (e.g., a port of the receiving network device).
Network Device Identifier 560 (e.g., words 2-3): This field includes an identifier of a network device (e.g., switch, director, router, appliance, etc.) to be removed from, e.g., the storage area network. For instance, it includes an identifier of a network device for which paths of the network device are to be removed (e.g., unenabled, deleted, switched offline, etc.). Various types of identifiers may be used, and the identifiers may be of various sizes. Therefore, the number of bytes and/or words allocated in the command structure (e.g., command structure 550) depends on the type and/or size of the identifier. One example type of identifier is a World Wide Node Name (WWNN), which is, for instance, 8 bytes in size. However, other types of identifiers, other sizes of the WWNN and/or other identifiers, and/or various types of network devices may be specified. Many examples are possible.

In other examples, additional network device identifiers may be specified using, e.g., bytes/words of the command structure. Many examples are possible.
Status 570 (e.g., word 4): This field includes, for instance, 1 byte of status relating to the removal of the network device (e.g., path(s) of the network device). The status may be an overall indication of the status for the network device to be removed or for all the paths of the network device to be removed and/or it might provide a more granular status for one or more selected paths (and/or one or more ports, links, etc.). Many examples are possible.

Further, if additional network devices are specified to be removed, additional status may be provided in the same word and/or in different words. Many examples are possible.

Further details regarding the status (e.g., status 570) are described with reference to FIG. 5C. In one example, status 570 includes:

Bit 0 when turned on (e.g., set to 1) indicates successful removal 572;

Bit 1 when turned on (e.g., set to 1) indicates failure 574;

Bit 2 when turned on (e.g., set to 1) indicates unknown status 576; and

Bits 3-7 are reserved 578.

Many other examples are possible, including but not limited to, other statuses, other bits for a particular status, more than one bit per status, etc.

Although in the example information described herein, specific words/bytes/bits are indicated for the fields, other words/bytes/bits may be used for the specific fields. Further, although the words/bytes/bits are set to specific values for one purpose or another, the words/bytes/bits may be set to the opposite values and/or different values. The particular words/bytes/bits and/or values described herein are just examples. Moreover, other example information and/or command structures may include additional, fewer, and/or other fields. In one or more embodiments, one or more of the fields may include an indicator (e.g., a bit) to be used to indicate whether that particular data of the field is to be populated/returned. In other examples, it is assumed that the data of the fields is to be populated/returned. Further, one or more fields may be ignored, left blank and/or not included in the command structure. Many variations and examples are possible.

Returning to FIG. 4, process 400 transmits 440 the built command (e.g., using transmit command code 308) to a receiving device. For instance, process 400 transmits the command from, e.g., the operating system (e.g., operating system 224) to a selected receiving network device (e.g., a selected network device 210 (e.g., a switch, director, router, appliance, etc.)) using, e.g., a local port (e.g., a port 222) and one or more links (e.g., links 230). The receiving network device receives the command (e.g., using a port (e.g., a port 212)) and based on the command, initiates and/or performs network device (e.g., path) removal for the selected network device(s) identified in the command. As examples, the receiving network device initiates network device (e.g., path) removal itself and/or uses other devices (e.g., other network devices and/or other devices) and/or components of the storage area network to initiate and/or perform network device (e.g., path) removal. The receiving network device prepares a response that includes status relating to the network device (e.g., path) removal and forwards the response to the transmitting device (e.g., device 220). Various examples are possible.

In one example, process 400 obtains 450 a response (e.g., using obtain response code 310) based on the requested network device removal. As an example, the response includes the command structure (e.g., command structure 550) with the status relating to the request. Other examples are possible.

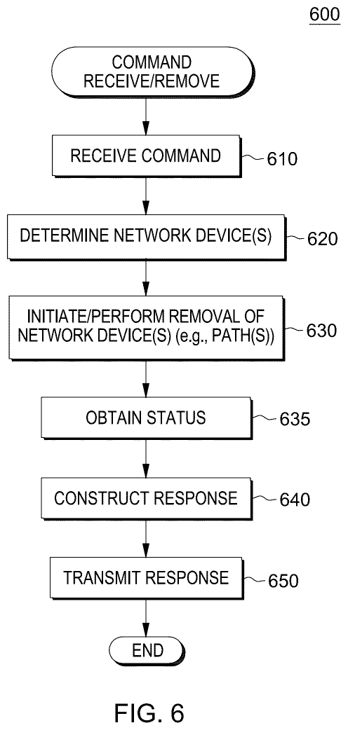

Further details related to processing by the receiving network device are described with reference to FIG. 6. In one example, the constructed command is received at the receiving device (e.g., a receiving network device 210 identified by, e.g., target port address identifier 554) in order to initiate and/or perform network device (e.g., path) removal for the selected network device(s). In one example, code of network device (e.g., path) removal code 150 is used, in accordance with one or more aspects of the present disclosure, to receive the command, initiate and/or perform network device (e.g., path) removal and/or perform other tasks related thereto, as described with reference to FIG. 6. In one example, a command receive/remove process (e.g., a command receive/remove process 600) is implemented using code 350-358 and is executed by one or more devices, such as one or more network devices 210, as described herein. In one example, network device 210 includes a switch, a director, a router, an appliance and/or another network device. A network device may have processing circuitry. In other examples, other devices, other than network devices, may also receive a network device removal command and/or perform one or more actions to initiate and/or perform network device (e.g., path) removal. In one example, the network device receiving the command may initiate and/or perform network device (e.g., path) removal of that network device and/or send the command, or an indication of the command, to one or more other network devices (and/or other devices and/or components) to initiate and/or perform network device (e.g., path) removal for one or more network devices. Various options and examples are possible.

In one example, process 600 executing on a device (e.g., network device 210) receives 610 the command (e.g., using receive command code 352) and determines 620 the one or more network devices to be removed. For instance, process 600 obtains an indication of the one or more selected network devices from one or more fields (e.g., network device identifier field 560) of the command structure (e.g., command structure 550).

Further, process 600 initiates and/or performs 630 the removal (e.g., using remove network device(s) (e.g., path(s)) code 354) of the one or more network device(s) indicated in the command. In one example, the receiving network device initiates the network device (e.g., path) removal for the network device(s) indicated in the command, which may be itself and/or one or more other network devices. To initiate removal, the receiving network device may begin the removal process for one or more paths of the network device(s) indicated in the command and/or send the command or an indication of the command to one or more other devices (e.g., network devices) that will initiate and/or perform the removal. To perform removal of a network device (e.g., paths of the network device), in one example, ports of the network device (e.g., ports coupled (e.g., attached) to the network device and/or ports on other devices used to communicate with the network device) are removed, e.g., unenabled, deleted, switched offline, etc. In one example, network devices of the storage area network remove (e.g., unenable, delete, switch offline, etc.) all the ports across, e.g., all the network devices (e.g., switches) being managed by the receiving network device that are attached to the specified network device. To further explain, in one or more examples, a path is removed by removing (e.g., unenabling, deleting, switching offline, etc.) one or more ports of the path. For instance, if a network device (e.g., network device A) is to be removed and thus, the paths of the network device (e.g., network device A) are to be removed, then the ports of that network device are, e.g., removed (e.g., unenabled, deleted, switched offline, etc.). In another example, the ports of other devices (e.g., network devices and/or non-network devices) coupled to network device (e.g., network device A) via the paths may be removed. Other examples are possible.

In other examples to remove a network device, one or more links of the network device are removed (e.g., unenabled, deleted, switched offline, etc.); the network device is shut-off; identifiers of network device are removed from routing tables; etc. Many examples are possible.

Based on performing the removal, process 600 obtains status 635 of the removal. The status may be for the network device, all of the paths to be removed, all the ports to be removed, selected paths, selected ports, etc. The status may be success, fail, unknown, etc. Other examples are possible.

If a network device performing the removal is not the receiving network device, the network device provides status of the removal to the receiving network device. For instance, it provides the status based on receiving at least an indication of the command from the receiving network device and performing the network device (e.g., path) removal. In another example, the receiving network device obtains the status from one or more other devices and/or components within and/or coupled to the storage area network. Many examples are possible.

In one example, if the receiving network device is the device selected to be removed, the receiving network device initiates and performs path removal for the paths except the one in which status is to be sent back to the transmitting device. Then, subsequent to submitting the status, this path is removed. For example, the port of the network device being removed that is associated with this path is removed (e.g., unenabled, deleted, switched offline, etc.). In one example, the status provided indicates that this path will be removed after transmission of the status. Other examples are possible.

In one example, based on obtaining the requested status, process 600 constructs 640 a response (e.g., using construct response code 356). This includes, for instance, entering the status in the command structure. For instance, process 600 populates the field(s) storing status 570 (e.g., success 572, fail 574 and/or unknown 576). Further, in one or more embodiments, process 600 may populate and/or update one or more other fields. Other examples are possible.

Further, the response is transmitted 650 (e.g., using transmit response code 358) to the transmitting device, which is identified, for instance, by source port address identifier 552 of command structure 550. Other examples are possible.

In one example, the control program (e.g., operating system 224) of the transmitting device receives the response and may take action based on the response. For instance, it may adjust a network routing path, enable/unenable certain ports, links and/or network devices, adjust the amount of traffic sent on a link, choose a link path, etc. The action taken depends, for instance, on the received status and a determination of an approach to be implemented to, e.g., improve the network (e.g., storage area network) to facilitate communication and/or processing within the computing environment. Many variations are possible.

In one or more aspects, a capability is provided to build a command, such as a control unit port command, and send the command to a network device (or other device) of, e.g., a storage area network (or other network) to perform network device (e.g., path) removal for one or more network devices (e.g., switches, directors, routers, appliances, etc.) or other devices of, e.g., a storage area network. This enables another device, such as an operating system executing on the other device, to request network device (e.g., path) removal, which may be used to improve component operations, communications and processing within a computing environment.

In one example, the operating system (e.g., operating system 224) is afforded the ability to use a structured command, architecturally defined, to request network device (e.g., path) removal for network device(s) (e.g., switches, directors, routers, appliances, etc.) indicated in the command. The request by the operating system may be programmatically sent based on information possessed, obtained, determined, perceived, etc. at the operating system side (i.e., not the network device side). In one or more aspects, it provides the operating system with an ability, previously not afforded, to request removal of network device(s) to enable the operating system to remove a network device (e.g., paths to a network device) in which there is a concern (e.g., performance, security vulnerability, etc.) and/or make other routing decisions.

As an example, the command is built and sent by the operating system executing on a non-network device based on I/O configuration data, such as access to an I/O configuration data set, other I/O configuration information, other information obtained (e.g., location information, security information) and/or performance data (e.g., related to data transmission, etc.), etc. It allows one tool (e.g., the operating system) to have control of the request and when to request it. It allows the operating system to take action prior and/or subsequent to performing the action (e.g., remove a device (e.g., paths of a device)) since it has control of when to request network device (e.g., path) removal. It provides the computing environment on which the operating system executes (e.g., the mainframe, etc.) to now have control over using selected network devices and/or the paths of selected network devices (e.g., switch, director, router, appliance, etc.). Many examples are possible.

In one or more aspects, the status of the network device (e.g., path) removal is used by a host system (e.g., operating system) to make decisions, for example, on routing traffic through one or more storage area networks. It allows routing decisions to be made for data centers, as an example. For instance, it may be decided to route traffic through a particular data center during selected times where bottlenecks are less prevalent, etc. It allows certain paths to be selected, enabled, unenabled, etc. Many other examples are possible.

In one example, implementation and use of the command to request network device (e.g., path) removal does not depend on or require knowledge of the specific vendor(s) of the network devices (e.g., of the storage area network) or of the original equipment manufacturer's management software (or others) used by the network devices. The command is not network device-or storage area network-vendor specific, allowing the command to be used by the operating system for network devices/components offered by various vendors.

One or more aspects of the present disclosure are tied to computer technology and facilitate processing within a computer, improving performance thereof. For instance, communication within a computing environment is improved by providing a capability to remove network device(s) of, e.g., a storage area network. A capability is provided for the host device to request network device (e.g., path) removal for one or more switches (or other network devices) within a storage area network. Processing within a processor, computer system and/or computing environment is improved.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer-readable code into a computing system, in which the code in combination with the computing system is capable of performing one or more embodiments.

Yet as a further aspect, a process for integrating computing infrastructure comprising integrating computer-readable code into a computer system may be provided. The computer system comprises a computer-readable medium, in which the computer-readable medium comprises one or more embodiments. The code in combination with the computer system is capable of performing one or more embodiments.

Although various embodiments are described above, these are only examples. For example, other techniques to request network device (e.g., path) removal may be used. Further, services and/or commands may be used to request network device (e.g., path) removal. Moreover, additional, less and/or other information may be transmitted/populated using the control unit port command to request network device (e.g., path) removal. Yet further, networks other than storage area networks may use one or more aspects of the present disclosure. Further, the storage area network may be separate and/or different from storage 124. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product comprising:
a set of one or more computer-readable storage media; and
program instructions, collectively stored in the set of one or more computer-readable storage media, for causing at least one device to perform computer operations including:
obtaining, by a receiving network device, a command built to enable a control program of a device coupled to the receiving network device to request removal of a network device, the command including an indication of the network device;
initiating, by the receiving network device, removal of the network device indicated by the command, the initiating removal of the network device including initiating removal of one or more paths of the network device; and
providing, by the receiving network device, a response to the request for removal of the network device.

2. The computer program product of claim 1, wherein the initiating removal of the one or more paths includes initiating a removing of one or more ports coupled to the network device.

3. The computer program product of claim 2, wherein the one or more ports are across a plurality of switches of a storage area network, the storage area network including the network device.

4. The computer program product of claim 1, wherein the response includes status of the removal of the one or more paths.

5. The computer program product of claim 4, wherein the status is selected from a group of statuses consisting of success, failure and unknown status.

6. The computer program product of claim 1, wherein the initiating the removal of the network device includes forwarding at least an indication of the command to at least one network device coupled to the receiving network device to initiate the removal of the network device.

7. The computer program product of claim 1, wherein the command is a control unit port command constructed based on a defined format and uses a command structure built to be used with the command, the command structure provided to the receiving network device and including the indication of the network device.

8. The computer program product of claim 7, wherein the command structure further includes one or more fields to include status of the request for removal of the network device.

9. The computer program product of claim 1, wherein the receiving network device is a same device as the network device.

10. The computer program product of claim 1, wherein the receiving network device is a different device than the network device.

11. The computer program product of claim 1, wherein the command includes a plurality of indications of a plurality of network devices to be removed.

12. A computer system comprising:
at least one device;
a set of one or more computer-readable storage media; and
program instructions, collectively stored in the set of one or more computer-readable storage media, for causing the at least one device to perform computer operations including:
obtaining, by a receiving network device, a command built to enable a control program of a device coupled to the receiving network device to request removal of a network device, the command including an indication of the network device;
initiating, by the receiving network device, removal of the network device indicated by the command, the initiating removal of the network device including initiating removal of one or more paths of the network device; and
providing, by the receiving network device, a response to the request for removal of the network device.

13. The computer system of claim 12, wherein the initiating removal of the one or more paths includes initiating a removing of one or more ports coupled to the network device.

14. The computer system of claim 12, wherein the response includes status of the removal of the one or more paths.

15. The computer system of claim 12, wherein the initiating the removal of the network device includes forwarding at least an indication of the command to at least one network device coupled to the receiving network device to initiate the removal of the network device.

16. A computer-implemented method of facilitating processing within a computing environment, the computer-implemented method comprising:
obtaining, by a receiving network device, a command built to enable a control program of a device coupled to the receiving network device to request removal of a network device, the command including an indication of the network device;
initiating, by the receiving network device, removal of the network device indicated by the command, the initiating removal of the network device including initiating removal of one or more paths of the network device; and
providing, by the receiving network device, a response to the request for removal of the network device.

17. The computer-implemented method of claim 16, wherein the initiating removal of the one or more paths includes initiating a removing of one or more ports coupled to the network device.

18. The computer-implemented method of claim 16, wherein the response includes status of the removal of the one or more paths.

19. The computer-implemented method of claim 16, wherein the initiating the removal of the network device includes forwarding at least an indication of the command to at least one network device coupled to the receiving network device to initiate the removal of the network device.

20. The computer-implemented method of claim 16, wherein the command is a control unit port command constructed based on a defined format and uses a command structure built to be used with the command, the command structure provided to the receiving network device and including the indication of the network device.
